(19) United States
(12) Patent Application Publication
(10) Pub. No.: US 2026/0006140 A1
(43) Pub. Date: Jan. 1, 2026

(54) SCANNER AND NON-TRANSITORY COMPUTER READABLE STORAGE MEDIUM

(71) Applicant: BROTHER KOGYO KABUSHIKI KAISHA, Nagoya (JP)

(72) Inventor: Jun OKAJIMA, Nagoya (JP)

(21) Appl. No.: 19/240,091

(22) Filed: Jun. 17, 2025

(30) Foreign Application Priority Data
Jun. 27, 2024 (JP) 2024-103961

(51) Int. Cl. H04N 1/00; H04N 1/387

(52) U.S. Cl. CPC H04N 1/00811; H04N 1/00209; H04N 1/00244; H04N 1/00413; H04N 1/3873; H04N 2201/0094

(57) ABSTRACT

In a case in which a scan instruction is received via a user interface, the scanner is configured to: scan a document by using a reading engine, and generate scan data indicating a document image based on a scan result; receive designation of a use for the document image; and transmit, to a server using a learned model, the scan data and use data indicating the use. In a case in which the determination information output by the learned model and including information as to whether the image indicated in the scan data is suitable for the use indicated in the use data is received from the server, the scanner is configured to execute a notification process of outputting, based on the determination information, a notification indicating whether the document image is suitable for the use.

### REFERENCE TO RELATED APPLICATIONS

This application claims priority from Japanese Patent Application No. 2024-103961 filed on Jun. 27, 2024. The entire content of the priority application is incorporated herein by reference.

### BACKGROUND ART

The technical field disclosed in the present specification relates to a scanner that reads a document image and outputs image data, and a program that controls the scanner.

A scanner generally generates image data of a read image in accordance with a reading setting corresponding to a type of a document image. A scanner according to an example of a technique is configured to receive a setting of a type of a document image and change a correction amount of a show-through in accordance with the type of the image set by a user.

### DESCRIPTION

There may be a need to confirm whether an image of a document prepared by a user in advance is suitable for a use. The above-described technique includes a configuration in which the scanner determines a correction amount of the image in accordance with the type of the image set by the user is disclosed, but does not include a configuration for determining whether the image is suitable for a use.

The scanner is configured to access a server via the communication interface, the server using a learned model that has learned so as to be configured to output, based on input data, determination information including information as to whether an image is suitable for a use. The scanner is configured to generate scan data indicating a document image based on a scan result. The scanner is configured to receive designation of a use for the document image via the user interface. The scanner is configured to transmit to the server the scan data and use data indicating the use received. The scanner is configured to execute a notification process of outputting, based on the determination information, a notification via the user interface, the notification indicating whether the document image read in the scan process is suitable for the use.

The scanner is configured to receive the designation of the use of the document image and transmit, together with information indicating the designated use, the scan data generated by scanning the document to the server using the learned model. Thereafter, in the case in which the determination information indicating whether the image is suitable and output by the learned model is received from the server, the scanner is configured to output the notification, through a user interface, whether the document image is suitable for the use based on the determination information. Accordingly, the user can confirm whether the document image prepared by the user is suitable for the use designated by the user.

A control method for implementing a function of the scanner, a computer program that controls the scanner, and a computer-readable storage medium that stores the computer program are also novel and useful.

According to the technique disclosed in the present specification, a technique that allows a user to confirm whether a document image prepared by the user is suitable for a predetermined use is implemented.

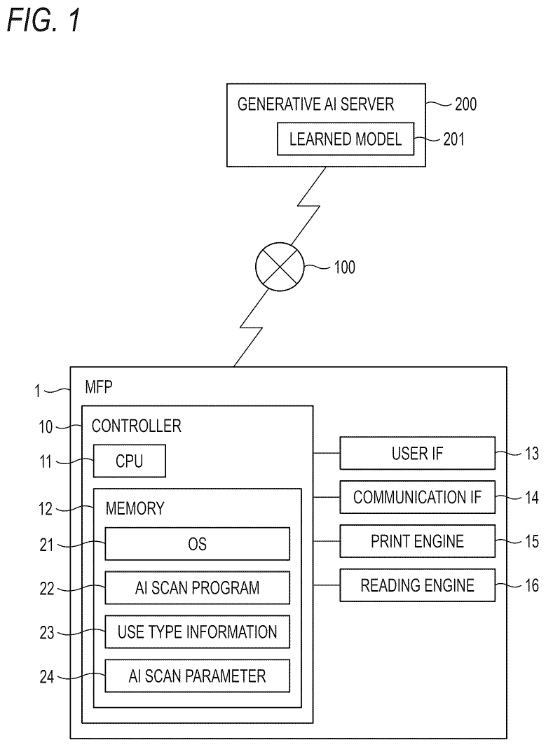

FIG. 1 is a diagram showing a schematic configuration of an MFP of the present embodiment.

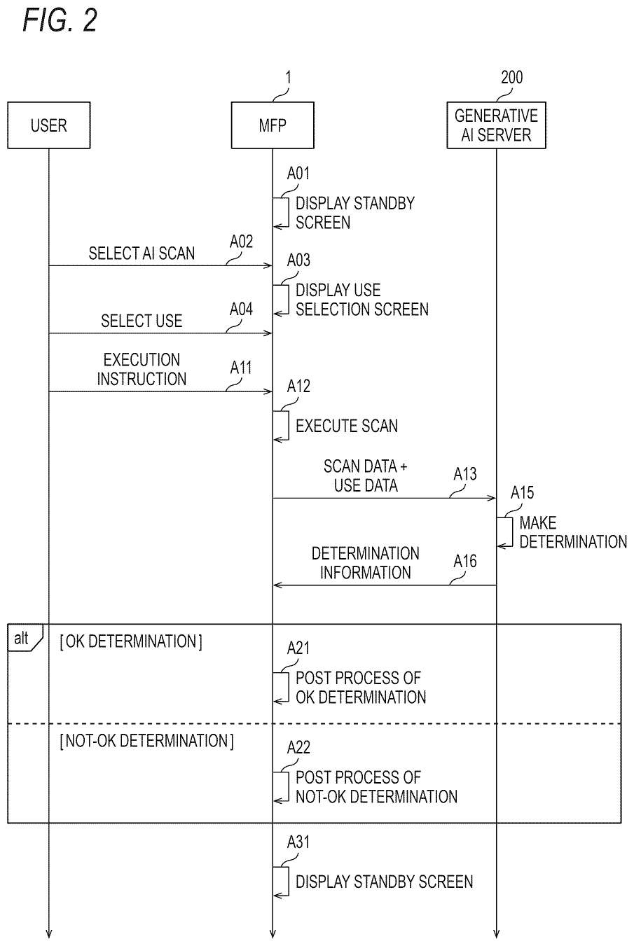

FIG. 2 is a sequence diagram showing an example of an AI scan procedure.

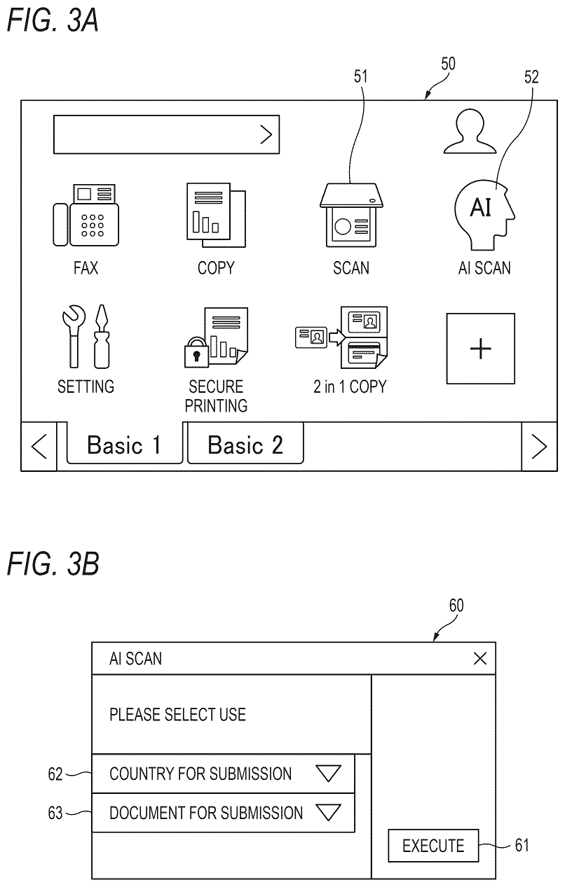

FIGS. 3A and 3B are diagrams showing an example of an operation procedure of executing a scan.

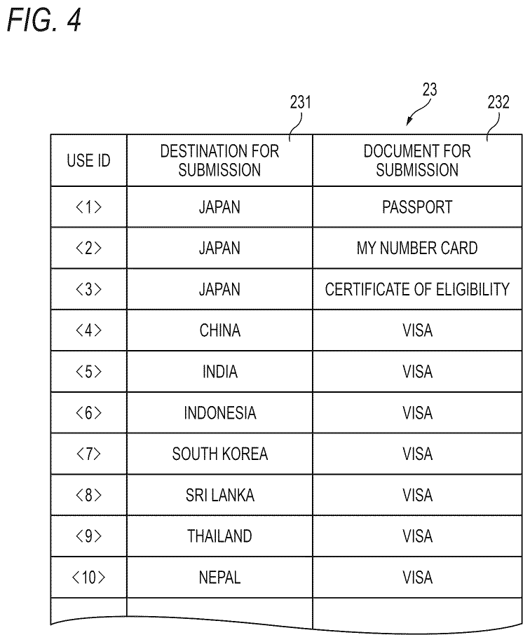

FIG. 4 is a diagram showing an example of use type information.

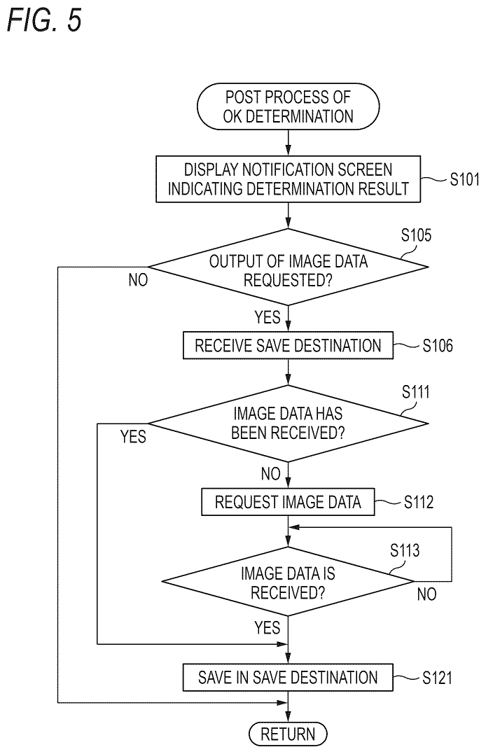

FIG. 5 is a flowchart showing an example of a procedure of a post process of OK determination.

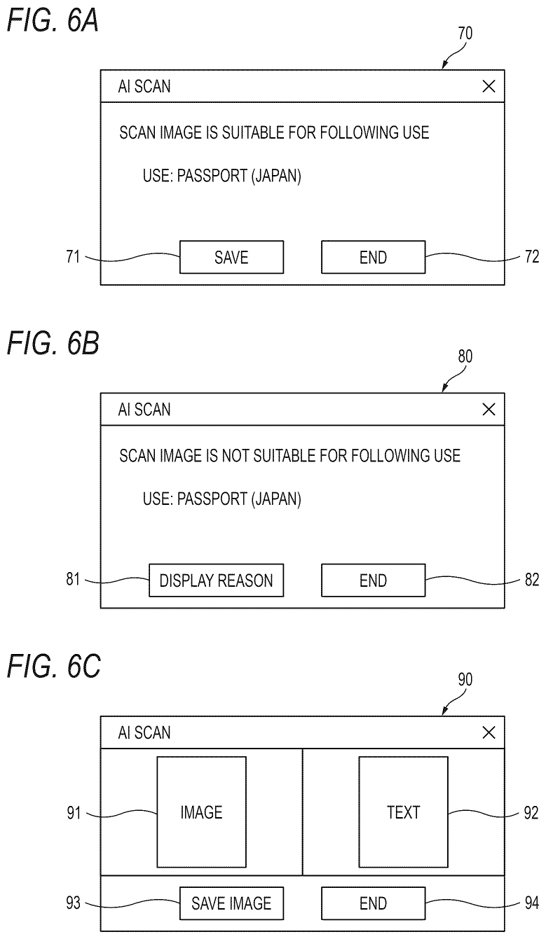

FIGS. 6A, 6B, and 6C are diagrams showing examples of a notification screen.

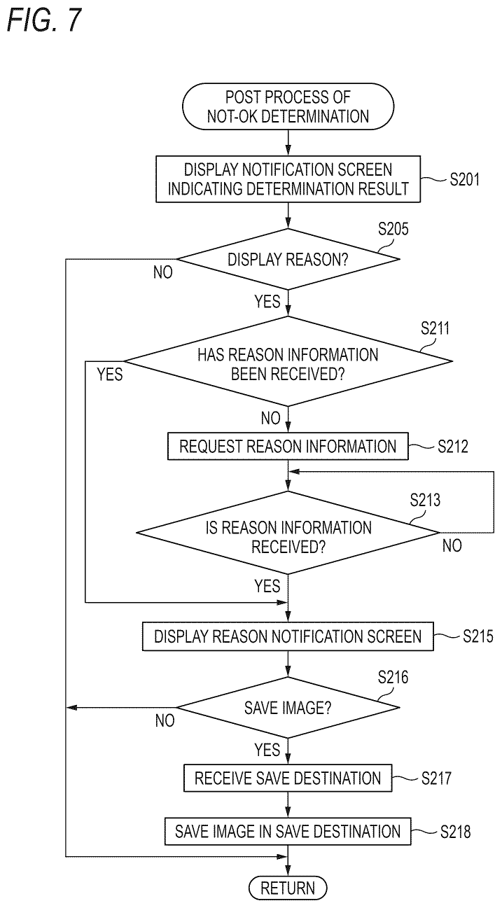

FIG. 7 is a flowchart showing an example of a procedure of a post process of not-OK determination.

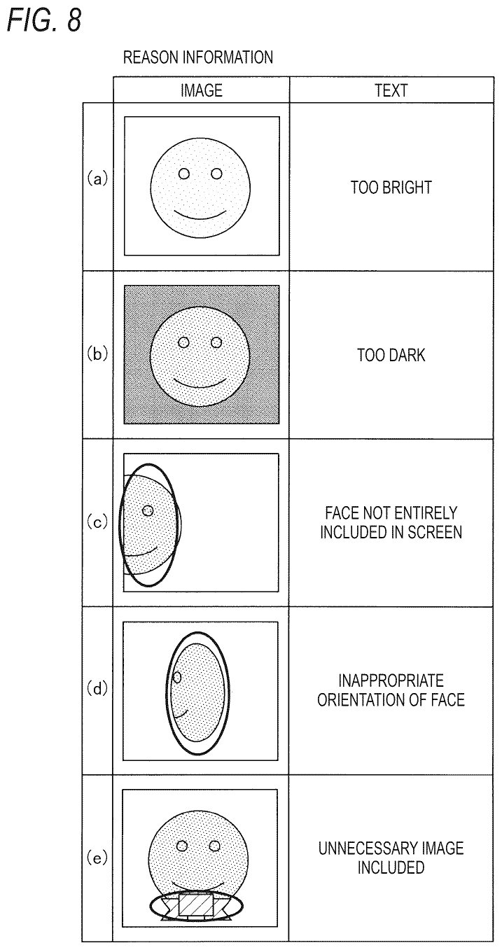

FIG. 8 is a diagram showing an example of reason images and reason texts.

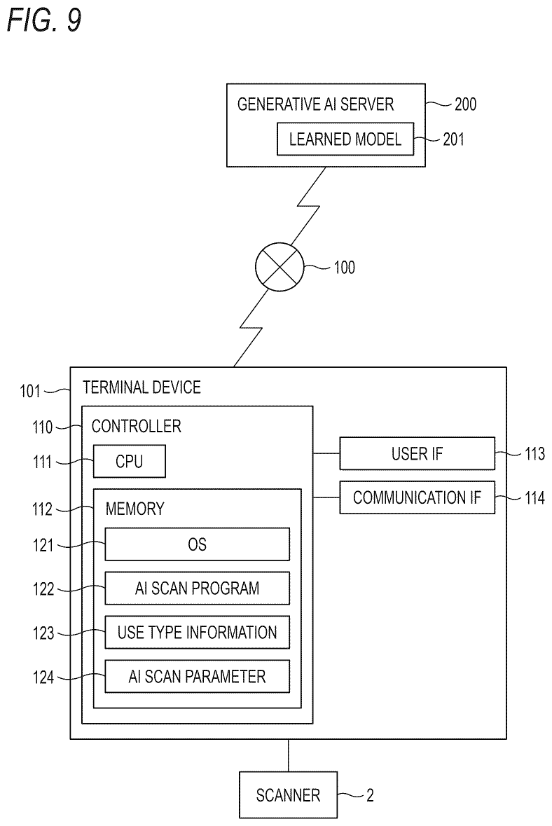

FIG. 9 is a diagram showing a schematic configuration of a terminal device.

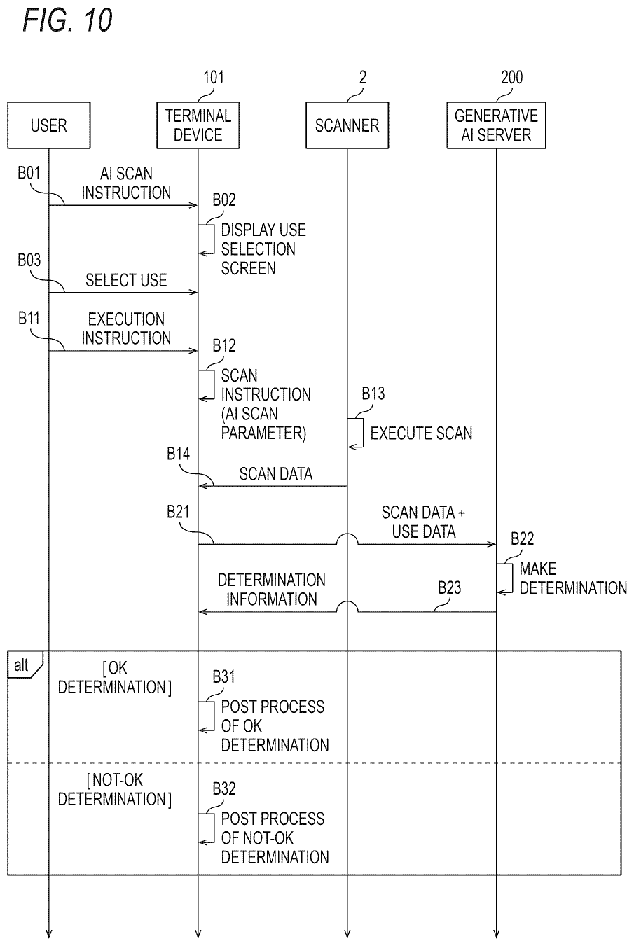

FIG. 10 is a sequence diagram showing an example of an AI scan procedure.

Hereinafter, a first embodiment embodying a scanner will be described in detail with reference to the accompanying drawings. The present specification discloses a multi function peripheral (hereinafter, referred to as “MFP”) having various functions including an image reading function and a communication function.

As shown in FIG. 1, an MFP 1 according to the present embodiment includes, for example, a controller 10 including a CPU 11 and a memory 12. The MFP 1 includes a user interface (hereinafter, referred to as a “user IF”) 13, a communication interface (hereinafter, referred to as a “communication IF”) 14, a print engine 15, and a reading engine 16 that are electrically connected to the controller 10. The MFP 1 is an example of a scanner. The controller 10 in FIG. 1 is a collective term for hardware and software used to control the MFP 1, and does not necessarily represent a single piece of hardware actually present in the MFP 1.

The CPU 11 of the MFP 1 executes various types of processes, in accordance with a program read from memory 12 and based on a user operation. The memory 12 of the MFP 1 stores various types of programs including an operating system (hereinafter, referred to as an “OS”) 21 and an AI scan program 22, and various types of data including use type information 23 and an AI scan parameter 24 which is a parameter for AI scan. The memory 12 is used as a work area in a case where various types of processes are executed. A buffer provided in the CPU 11 is also an example of the memory 12. The program and data will be described later in detail.

An example of the memory 12 is not limited to a ROM, a RAM, an HDD, and the like incorporated into the MFP 1, and may be a storage medium configured to be read and written by the CPU 11. For example, an external memory such as a USB memory or an HDD connected to the MFP 1 via the communication IF 14 or a memory or an HDD provided in a device connected to the MFP 1 via the communication IF 14 is also an example of the memory.

The computer-readable storage medium is a non-transitory medium. The non-transitory medium also includes a recording medium such as a CD-ROM or a DVD-ROM, in addition to the above-described examples. The non-transitory medium is also a tangible medium. On the other hand, an electric signal conveying a program downloaded from a server or the like on the internet is a computer-readable signal medium, which is a kind of computer-readable medium, but is not included in the non-transitory computer-readable storage medium.

The user IF 13 includes hardware configured to display a screen for notifying a user of information, and hardware configured to receive an operation from the user. The user IF 13 may include a touch panel having a screen display function and an operation reception function, or may include a combination of a display, hardware buttons, and the like.

The communication IF 14 includes hardware for communicating with an external device. The communication IF 14 has functions compatible with communication standards such as Wi-Fi (registered trademark), Ethernet (registered trademark), and USB. The MFP 1 may include a plurality of communication IFs 14 corresponding to a plurality of communication standards.

The print engine 15 includes a configuration for printing an image on a print medium such as a sheet. An image formation method of the print engine 15 is, for example, an electrophotographic method or an ink-jet method. The print engine 15 may be configured to perform multicolor printing or may be configured to perform only monochrome printing.

The reading engine 16 includes a configuration for scanning a document placed on a flatbed or a document placed on a document feeder and conveyed to a reading position, and generating scan data as a scan result. The MFP 1 of the present embodiment includes the reading engine 16 capable of executing both color reading for reading a document as a color image and monochrome reading for reading a document as a monochrome image.

The MFP 1 can be connected to an Internet 100 via the communication IF 14, and can access a generative AI server 200 via the Internet 100, for example, as shown in FIG. 1. The generative AI server 200 includes a learned model 201 that has learned in advance using various types of data to output answer data based on input data. The generative AI server 200 is an example of a server that uses the learned model. The learned model 201 may be a server of an AI business operator, which is published on the Internet 100. Examples of the AI business operator include OpenAI, Inc.

Upon receiving input of image data and information indicating a use of the image data, the learned model 201 has learned to be capable of analyzing the image data and determining whether the image data is suitable for the input use. That is, the learned model 201 has learned information indicating uses of various images and information indicating a condition of an image allowed for each use, and can determine whether the image included in the input image data satisfies the condition for being used in the input use. For example, the learned model on the server provided by the AI business operator performs learning by using big data. Therefore, it can be expected that the learned model 201 can analyze the input image data and determine whether the image data is suitable with high accuracy. For example, when the use of the image is a photograph used for applying a passport or a visa, the learned model 201 may have learned information indicating a condition to be satisfied in accordance with a country or a region to be applied.

The generative AI server 200 may be provided with an API for causing the learned model 201 to determine whether the input image data is suitable and returning information of the determination result. For example, the MFP 1 may be capable of instructing the learned model 201 to output the determination result by inputting the image data and the information indicating the use to the predetermined API provided in the generative AI server 200.

Alternatively, the generative AI server 200 may have a chat function. When a question to the chat function is received, the generative AI server 200 may be capable of outputting an answer indicating a determination result generated by the learned model 201 based on the received question to a device that inputs the question. For example, the MFP 1 may input the image data, the information indicating the use of the image data, and a character string (for example, a prompt) for requesting determination of whether the image data is suitable for the use to the chat function of the generative AI server 200 to instruct the learned model 201 to determine the suitability.

Next, a procedure related to the image determination by the MFP 1 will be described. The following processes basically represent processes of the CPU in accordance with commands written in programs. That is, the processes such as “judge”, “extract”, “select”, “calculate”, “determine”, “specify”, “acquire”, “receive”, and “control” to be described below represent the processes of the CPU. The processes by the CPU also include hardware control using the API of the OS. In the present specification, the description of the OS is omitted, and an operation of each program is described. That is, in the following description, the description that “a program B controls hardware C” may refer to “the program B controls the hardware C, using the API of the OS”. In addition, the processes of the CPU in accordance with the commands written in the programs may be described in omitted words. For example, the processes of the CPU may be described as “the CPU performs”. In addition, the processes of the CPU in accordance with the commands written in the programs may be described in words in which the CPU is omitted, such as “the program A performs”.

In addition, in the present specification, “notify”, “notice”, “announce”, “reply”, “response”, “answer”, and the like are not limited to a meaning of transmission of information to a person, and are also used as words meaning communication or exchange of information between devices or between components in a device. The configuration in the device includes software.

The term “acquire” is used as a concept indicating that a request is not essential. That is, a process of receiving data without a request from the CPU is also included in a concept indicating that “the CPU acquires data”. In addition, the term “data” in the present specification is represented by a computer-readable bit string. Furthermore, data having substantially the same meaning and different formats are treated as the same data. The same applies to “information” in the present specification. In addition, the term “request” or “instruct” is a concept indicating that information indicating that a request is being made or information indicating that an instruction is being given is output to a partner. In addition, the information indicating that a request is being made or the information indicating that an instruction is being given is simply referred to as a “request” or “instruction”.

According to the CPU, a process of determining whether information A indicates that it is a matter B may be conceptually described as “determining whether it is the matter B, based on the information A”. According to the CPU, a process of determining whether the information A indicates that it is the matter B or a matter C may be conceptually described as “determining whether it is the matter B or the matter C, based on the information A”.

In the present specification, a setting item may be simply referred to as “setting”. A setting value may be simply referred to as “setting”. The setting value may be described as a “parameter”. Furthermore, storing the setting value in a memory or the like may be simply referred to as “setting”. An operation for setting or input for setting may be simply referred to as “setting”.

An AI scan procedure executed by the MFP 1 will be described with reference to a sequence diagram of FIG. 2. The AI scan procedure is started when the MFP 1 becomes ready to receive an instruction for an AI scan. The AI scan procedure of the present embodiment is a procedure of scanning a document including a facial photograph and determining whether the scan result is suitable for a use of a photograph used for an application to a predetermined institution. That is, the document to be scanned in the AI scan procedure of the present embodiment is assumed to be a facial photograph attached to various application documents.

When the MFP 1 is in a standby state, a standby screen can be displayed on the user IF 13 (A01). For example, as shown in FIG. 3A, the MFP 1 displays a standby screen 50 including a scan icon 51 and an AI scan icon 52. In addition to these icons, a plurality of icons capable of receiving instructions for various functions executable in the MFP 1 are displayed on the standby screen 50. The MFP 1 can receive an operation from the user on each of the icons to receive a selection of a function corresponding to the operated icon. However, in the following, functions related to the scan will be described, and descriptions of functions other than the scan will be omitted.

The scan icon 51 is an icon for receiving an instruction to execute the scan to generate scan data and save the scan data in a designated save destination. When an operation on the scan icon 51 is received, the MFP 1 can receive a setting operation of a parameter related to the generation of the scan data. The parameter includes a parameter for a scan resolution setting item, a parameter for a color setting item indicating whether to perform color reading, and a parameter indicating whether to perform a correction process on data after reading. When the MFP 1 receives a setting operation of designating a parameter, the MFP 1 executes the scan using the parameter designated by the setting operation. That is, for the user, the user himself or herself needs to determine the respective parameters necessary for obtaining the scan data desired by the user and needs to perform an operation for designating the necessary parameters on the MFP 1 by the user. The scan icon 51 is an example of an operator corresponding to the scan.

The AI scan icon 52 is an icon for receiving an instruction to start the AI scan procedure. When the operation on the AI scan icon 52 is received, the MFP 1 does not receive the setting operation of the parameter related to the generation of the scan data described above. The operation on the AI scan icon 52 is an example of a predetermined scan instruction.

The user selects the AI scan procedure by operating the AI scan icon 52 in the user IF 13 (A02). When the operation on the AI scan icon 52 is received, the MFP 1 displays a use selection screen 60 for receiving the selection of the use of the image (A03), for example, as shown in FIG. 3B. The use selection screen 60 includes, for example, an execution button 61 that receives an instruction to determine the use and start scanning, a “submitted country” button 62, and a “submitted document” button 63.

The MFP 1 receives the selection of the use via the operation on the buttons 62 and 63. When an operation on the “submitted country” button 62 is received, the MFP 1 displays options of a country or a region as a submission destination to which documents including a document to be scanned are submitted, and receives the selection of the user. When an operation on the “submitted document” button 63 is received, the MFP 1 displays options of types of the documents and receives the selection of the user.

The MFP 1 stores, as the use type information 23, for example, information in which a submission destination 231 and a submission document 232 are associated with each other, as shown in FIG. 4. The MFP 1 displays the options when the operation on the button 62 or the button 63 is received based on the use type information 23 stored in the memory 12. For example, when the MFP 1 receives the operation on the button 62, the MFP 1 displays a list of the submission destinations 231 such as “Japan”, “China”, and “India” as options, and receives a selection of submission destination information indicating a country or a region as the submission destination.

When the MFP 1 receives the operation on the button 63, the MFP 1 displays, as options, a list of the submission documents 232 that can be combined with the submission destination information received through the operation on the button 62, such as “passport” or “visa”, and receives a selection of document information indicating the submission document. The MFP 1 may receive the selection of the document information through the operation on the button 63 and then receive the selection of the submission destination information through the operation on the button 62.

The user designates the use of the image through the selection operations based on the button 62 and the button 63 on the use selection screen 60 being displayed (A04). A04 is an example of a designation process. Accordingly, the MFP 1 acquires information such as the selected submission destination information and the selected document information. Hereinafter, a combination of the submission destination information and the document information is referred to as “use data”. FIG. 4 is a diagram showing a correspondence between a use ID and use data that is a combination of the submission destination information and the document information.

The uses that are capable of being designated in the MFP 1 include a use of a photograph used for a passport application. For example, use data of a use ID<1> is use data indicating a use of a photograph used for a passport application to Japan. That is, when “Japan” is selected as the submission destination information and “passport” is selected as the document information, the MFP 1 determines that the “use data of use ID<1>” is selected.

In addition, the uses that are capable of being designated in the MFP 1 include a use of a photograph used for a visa application to a specific country. For example, use data of a use ID<4> is use data indicating a use of a photograph used for a visa application to China. That is, when “China” is selected as the submission destination information and “visa” is selected as the document information, the MFP 1 determines that the “use data of use ID<4>” is selected.

Instead of receiving the selections of the submission destination information and the document information through the operations on the two buttons, the MFP 1 may display a use data list in which the submission destination 231 and the submission document 232 are combined as options through an operation on one button, and receive a selection of the user with respect to the combination of the submission destination information and the document information. Alternatively, the MFP 1 may first receive a selection between a domestic use and an overseas use, and then receive a selection of a document if the use is domestic, and a selection of a target country if the use is overseas. In addition, for example, when a selection of “passport” or “my number card” is received as the document information, the MFP 1 may determine the submission destination information without receiving a selection of the submission destination by the user because the application is limited to an application of the document issued from the own country.

The user selects the use of the image and performs the operation on the execution button 61 in a state where the document is set on the flatbed or on the document feeder, to instruct the start of the scan (A11). The operation on the execution button 61 may be an example of a predetermined scan instruction. The MFP 1 may not receive the operation on the execution button 61 until the selection of the use is received.

Upon receiving the operation in A11, the MFP 1 drives the reading engine 16 to read the document image to generate the scan data (A12). A12 is an example of a scan process.

In the AI scan procedure, the MFP 1 does not receive a parameter setting instruction, and in A12, the MFP 1 executes the scan using the AI scan parameter 24 stored in the memory 12 since shipment of the MFP 1. The AI scan parameter 24 is information of a parameter group suitable for executing the AI scan for various setting items related to the generation of the scan data. That is, when the AI scan is executed by the operation on the AI scan icon 52, the user does not need to perform the setting operation of the parameter for scanning the document, and can start the procedure with a simple operation. The AI scan parameter 24 may be a parameter different depending on use data, and in this case, the MFP 1 determines the parameter to be used in A12 based on the use data selected in A04.

The AI scan parameter 24 is a parameter for generating the scan data suitable for causing the learned model 201 to determine the suitability in a subsequent procedure. In the AI scan parameter 24, for example, a parameter of “color” is set regarding the color setting item, and a parameter of “high resolution” is set regarding the scan resolution setting item. Since the setting operation of the parameters is not received in the AI scan procedure, the MFP 1 can avoid scanning the document with inappropriate parameters. The AI scan parameter 24 does not include a parameter indicating that data correction is performed after reading or information indicating an output destination of the scan data.

Then, the MFP 1 instructs the generative AI server 200 to answer whether the image included in the scan data is suitable for the use indicated in the use data. In this case, the MFP 1 transmits the scan data generated in A12 and the use data of the use ID indicating the use selected by the user in A04 to the generative AI server 200 (A13). For example, the MFP 1 may perform the instruction by transmitting the scan data and the use data to the generative AI server 200 via a dedicated API, or may perform the instruction by a prompt. A13 is an example of a transmission process.

The scan data transmitted by the MFP 1 to the generative AI server 200 in A13 may be data as a reading result acquired by the reading engine 16, that is, RAW data, or may be data after being subjected to a process such as format conversion in the MFP 1. However, the MFP 1 does not perform image correction for modifying a content of the scan data. In A13, the MFP 1 may instruct the generative AI server 200 not to perform the image correction for modifying the content.

The image correction by the generative AI server 200 also includes image correction by the learned model 201. As the image correction for modifying the content, for example, correction for changing facial features, correction for changing a hairstyle, and correction for removing or adding an accessory such as a glass are considered. In addition, when the user submits a document of a paper document using a photograph itself, which is a scanned document, if it is assumed that the AI scan procedure is used to determine whether the photograph itself is suitable for the use, it is preferable that the MFP 1 and the generative AI server 200 do not perform the image correction, such as noise removal, edge enhancement, or smoothing, on the scan data to improve an appearance of the image to such an extent that the image cannot be said to be modified. On the other hand, when the user submits a document of an electronic document using the scan data, if it is assumed that the AI scan procedure is used to determine whether the photograph is suitable for the application, the MFP 1 and the generative AI server 200 may or may not perform the image correction on the scan data to improve the appearance of the image to the extent that the image cannot be said to be modified.

The generative AI server 200 may input the scan data received from the MFP 1 to the learned model 201 after performing the process within a range in which the content of the scan data is not modified. For example, the generative AI server 200 may trim the scan data and input only the facial photograph to the learned model 201. The MFP 1 scans a predetermined scan range to generate the scan data. Therefore, the scan data transmitted in A13 always includes, for example, unnecessary surrounding data around the facial photograph and is not trimmed. In the present specification, a case where the scan data transmitted by the MFP 1 is trimmed and input to the learned model 201 is also included in a category that the MFP 1 inputs the scan data to the learned model 201.

The generative AI server 200 uses the learned model 201 to determine whether the image indicated in the input scan data is suitable for the use indicated in the input use data, that is, the country or region as the submission destination and the type of the submission document (A15), and generates answer data including the determination information output by the learned model 201. Then, the generative AI server 200 outputs the generated answer data to the MFP 1 (A16). Accordingly, after executing the transmission in A13, the MFP 1 receives the determination information indicating the suitability of the image indicated in the scan data from the generative AI server 200 via the communication IF 14.

Photographs used for various applications have different standards for respective uses. For example, a photograph for a passport application to Japan has various standards such as a dimension, a background, a facial orientation, a facial expression, a decoration, and an image quality. In addition, for example, the standard of the photograph for the visa application may be different depending on the country or region. If the learned model 201 has learned the standard of the photograph depending on the use, the learned model 201 can determine whether the photograph is suitable for the use based on the input scan data and the input use data. In this case, the MFP 1 transmits the scan data and the use data to the generative AI server 200 to instruct the determination, so that the user can confirm whether the photograph of the document is suitable for the standard without accurately knowing the standard.

Note that the generative AI server 200 may transmit the data output by the learned model 201 to the MFP 1 after performing various types of processes within a range in which the content of the data is not greatly modified. In the present specification, a case where the MFP 1 receives the data subjected to various processes after being output by the learned model 201 is also included in the category that the MFP 1 receives the data output by the learned model.

If it is determined in the generative AI server 200 that the image is suitable for the use based on the determination information included in the answer data received from the generative AI server 200 (alt: [OK determination]), the MFP 1 executes a post process of OK determination (A21). A procedure of the post process of OK determination will be described with reference to a flowchart of FIG. 5. The post process of OK determination is executed in the CPU 11 of the MFP 1 based on the AI scan program 22.

In the post process of OK determination, the CPU 11 causes the user IF 13 to display a notification screen including information indicating that the image is suitable for the use (S101). S101 is an example of a notification process. For example, as shown in FIG. 6A, the CPU 11 displays a notification screen 70 including a message indicating that the document image is suitable for the use, a save button 71, and an end button 72. FIG. 6A is an example of a case where the designated use is a passport of Japan. For example, as shown in FIG. 6A, the CPU 11 may display the notification screen 70 including information indicating the use.

Then, the CPU 11 waits until an operation on the save button 71 or the end button 72 is received (S105). S105 is a process of receiving a selection of whether to output the image data, and is an example of an output selection process.

In a case of a use where the image data can be submitted or in a case where the image data is to be left as a record, the user performs the operation on the save button 71 to request output of the image data. The image data to be output is data based on the scan data generated in A12, and is data indicating an image including a facial image. On the other hand, in a case where the user only needs to know the determination result and submits a photograph of the document, the user operates the end button 72 to end the procedure.

If it is determined that the output of the image data is selected by receiving the operation on the save button 71 (S105: save), the CPU 11 receives a selection of the save destination (S106). For example, the CPU 11 may display a list of selectable save destinations and receive the selection of the user. The selectable save destinations include, for example, the memory 12 of the MFP 1, a USB memory attached to the MFP 1, and a memory of an external device connected to the MFP 1.

Then, the CPU 11 determines whether the image data for output has been received (S111). The answer data received from the generative AI server 200 in A16 of FIG. 2 may or may not include the image data. If it is determined that the answer data does not include the image data, that is, the image data has not been received (S111: NO), the CPU 11 requests the generative AI server 200 to transmit the image data (S112). The CPU 11 transmits an image acquisition request to the generative AI server 200 via the communication IF 14. Then, the CPU 11 waits until the image data is received from the generative AI server 200 (S113).

For example, in step S112, the CPU 11 may request the generative AI server 200 to transmit image data obtained by trimming a part of the image to have a size suitable for the use selected by the user in A04 of FIG. 2. For example, for each of the uses, if the learned model 201 has learned the size of the image data suitable for the use, there is a possibility that the MFP 1 is capable of receiving the image data that has been trimmed. As described above, there is a high possibility that the scan data generated in A12 of FIG. 2 is image data corresponding to a reading range in the MFP 1 and is not trimmed. If the image data obtained by trimming can be received from the generative AI server 200, the CPU 11 does not need to perform the trimming, and a process load of the MFP 1 is reduced. Since the image data obtained by trimming can be output, the user can easily use the image data.

The CPU 11 may request the generative AI server 200 to transmit the image data in a format suitable for the use selected by the user or a file in a file format suitable for the use selected by the user. For example, for each of the uses, if the learned model 201 has learned the image format or the file format suitable for the uses, there is a possibility that the MFP 1 is capable of receiving data in the image format or the file format suitable for the use.

If it is determined that the image data is received from the generative AI server 200 in response to the request (S113: YES), or if it is determined that the image data included in the answer data has been received (S111: YES), the CPU 11 generates a file including the received image data and saves the file in the selected save destination (S121). S121 is an example of an output process.

If the image data is received from the generative AI server 200 together with the determination information, the CPU 11 can immediately output the image data without making the request in S112. On the other hand, the answer data received from the generative AI server 200 is only information indicating the determination result, and if the CPU 11 requests the image data as necessary, unnecessary communication for receiving unnecessary image data can be avoided.

Instead of saving the image data, the CPU 11 may output the image data as, for example, image data for submission to an application destination server. If the image is appropriate, by outputting the image as image data in an appropriate image format, the user can use the image data. When the image data of the image format suitable for the use can be received from the generative AI server 200, the MFP 1 does not need to execute the process for generating the image data in the appropriate image format from the scan data generated in A12 of FIG. 2, and a process load of the scanner is reduced.

The CPU 11 may receive the selection of the save destination after receiving the image data in S113. When the operation on the AI scan icon 52 on the standby screen 50 (see FIG. 3A) is received, the CPU 11 may receive the selection of the save destination before starting scanning, or may receive the selection of the save destination after executing the scan and before or after transmitting the scan data to the generative AI server 200.

When the image data in the image format suitable for the use selected by the user and trimmed to a size suitable for the use selected by the user cannot be received from the generative AI server 200, the CPU 11 may perform image format conversion and a trimming process by itself and store the obtained data in the selected save destination.

After S121, or if it is determined that the user operation on the end button 72 is received on the notification screen 70 (S105: end), the CPU 11 ends the post process of OK determination and returns to the AI scan procedure of FIG. 2.

The description returns to the AI scan procedure of FIG. 2. If it is determined that the image is not suitable for the use based on the determination information included in the answer data received from the generative AI server 200 (alt: [not-OK determination]), the MFP 1 executes a post process of not-OK determination (A22). A procedure of the post process of not-OK determination will be described with reference to a flowchart of FIG. 7. The post process of not-OK determination is executed in the CPU 11 of the MFP 1 based on the AI scan program 22.

In the post process of not-OK determination, the CPU 11 causes the user IF 13 to display a notification screen including information indicating that the image is not suitable for the use (S201). S201 is an example of the notification process. For example, as shown in FIG. 6B, the CPU 11 displays a notification screen 80 including a message indicating that the document image is not suitable for the use, a reason display button 81, and an end button 82. FIG. 6B is an example of the case where the designated use is the passport of Japan. For example, as shown in FIG. 6B, the CPU 11 may display the notification screen 80 including information indicating the use.

Then, the CPU 11 waits until an operation on the reason display button 81 or the end button 82 is received (S205). S205 is an example of a display selection process.

If it is determined that an instruction to display the reason is received by the operation on the reason display button 81 (S205: YES), the CPU 11 determines whether the reason information has been received (S211). If the answer data received from the generative AI server 200 includes the reason information, the CPU 11 determines in S211 that the reason information has been received. If the reason information has been received, the CPU 11 may display the reason on the notification screen based on the received reason information without waiting for the reception of the operation on the reason display button 81. If the answer data including the reason information together with the determination information is received from the server, the CPU 11 can immediately notify the user of the reason information.

If the answer data does not include the reason information (S211: NO), the CPU 11 transmits a reason acquisition request for requesting transmission of the reason information to the generative AI server 200 (S212). Then, the CPU 11 waits until the reason information is received from the generative AI server 200 (S213). The CPU 11 may request the generative AI server 200 to transmit, as the reason information, at least one of a reason image indicating an inappropriate reason by an image and a reason text representing the inappropriate reason by text. The CPU 11 may instruct the generative AI server 200 on a usage language of the reason text. The reason image is an example of image data indicating the reason why the image is not suitable for the use by an image. The reason text is an example of text data indicating the reason why the image is not suitable for the use by a text.

If the reason information is requested to the generative AI server 200 when the determination information not including the reason information is first received and then an instruction to display the reason is received, the reason information is not received when it is unnecessary to display the reason, and thus unnecessary communication can be avoided.

If it is determined that the reason information is received from the generative AI server 200 in response to the request (S213: YES), or if it is determined that the reason information included in the answer data has been received (S211: YES), the CPU 11 causes the user IF 13 to display a reason notification screen including the received reason information (S215). S215 is an example of a display process. For example, as shown in FIG. 6C, the CPU 11 displays a reason notification screen 90 including a reason image 91 indicating the reason as an image, a reason text 92 indicating the reason as a text, an image save button 93, and an end button 94. The reason notification screen 90 may include at least one of the reason image 91 and the reason text 92.

For example, as shown in FIG. 8, the reason notification screen 90 includes the reason text 92 such as (a) too bright, (b) too dark, (c) the entire face is not included in the screen, (d) the orientation of the face is inappropriate, and (e) an unnecessary image is included, and the reason image 91 indicating an inappropriate portion. The reason image 91 is image data obtained by adding a mark indicating the inappropriate portion to the scan data transmitted to the generative AI server 200 in A13. The reason image 91 may have been trimmed or may have not been trimmed. When there are a plurality of reasons, the CPU 11 may display the reason images 91 in which all of the plurality of reason portions are marked, may display the reason notification screen 90 in which the plurality of reasons are arranged as the respective reason images 91, or may be capable of receiving a switching instruction of the reason images 91 by scrolling or the like.

The reason why it is determined that the image is not suitable for the use may include various reasons depending on the use, such as excessive or insufficient brightness of the facial image or the background, the orientation of the facial image, the size of the facial image being outside the allowable range, and noise included in the image. The noise of the image is a reason indicating that the image is a photograph including an image other than the facial image, and is pointed out when an object other than the facial image appears in the background or the foreground, or when strong reflected light appears. Depending on the use, there may be standards for hairstyle, facial expression, clothes, glasses, accessories, and the like. When the learned model 201 has learned the standard of the photograph for each of the uses and determines that the photograph is not suitable for the use, there is a high possibility that the learned model 201 can present the reason. That is, since the MFP 1 receives the reason information from the generative AI server 200 and displays the reason information as the reason notification screen 90, even if the user does not accurately know the standard, the user can easily know the reason why the photograph of the document is not suitable for the standard, and a possibility that an appropriate photograph coping with the reason can be prepared is increased.

Then, the CPU 11 waits until an operation on the image save button 93 or the end button 94 is received on the reason notification screen 90 (S216). If it is determined that an instruction to save the reason image 91 is received by the operation on the image save button 93 (S216: YES), the CPU 11 receives the designation of the save destination to save the reason image 91 (S217). The selectable save destinations include, for example, the memory 12 of the MFP 1, a USB memory attached to the MFP 1, and a memory of an external device connected to the MFP 1.

When the designation of the save destination is received, the CPU 11 saves the reason image 91 in the designated save destination (S218). The CPU 11 may save the reason text 92 together with the reason image 91. After S218, or if it is determined that the operation on the end button 82 is received on the notification screen 80 (S205: NO), or if it is determined that the operation on the end button 94 is received on the reason notification screen 90 (S216: NO), the CPU 11 ends the post process of not-OK determination and returns to the AI scan procedure of FIG. 2. The user who does not need the display of the reason performs the operation on the end button 82 on the notification screen 80. The user who does not need the saving of the reason image 91 performs the operation on the end button 94 on the reason notification screen 90.

The description returns to the AI scan procedure of FIG. 2. After the end of the post process of OK determination of A21 or the post process of not-OK determination of A22, the MFP 1 displays the standby screen (A31) and becomes able to receive the user operation.

As described above in detail, when the operation on the AI scan icon 52 is received, the MFP 1 of the first embodiment receives the designation of the use, scans the document to generate the scan data, and transmits the generated scan data and the use data indicating the use to the generative AI server 200 using the learned model 201. The learned model 201 has learned the image standard for each of the uses. When the determination information output from the learned model 201 is received, the MFP 1 makes a notification of the determination result of the learned model 201 indicated in the determination information via the user IF 13. Accordingly, the user can confirm whether the prepared document is suitable for the designated use.

Next, a second embodiment will be described in detail with reference to the accompanying drawings. The present embodiment is different from the first embodiment in which the AI scan procedure is executed in MFP 1 in that a terminal device 101 including a program for the AI scan procedure is used. The same configurations and procedures as those of the first embodiment are denoted by the same reference numerals as those of the first embodiment, and descriptions thereof will be omitted.

The terminal device 101 of the present embodiment includes a controller 110 including a CPU 111 and a memory 112 as shown in FIG. 9. The terminal device 101 is an example of an information processing device. The CPU 111 is an example of the computer. The terminal device 101 includes a user IF 113 and a communication IF 114 that are electrically connected to the controller 110.

The CPU 111 of the terminal device 101 executes various types of processes, in accordance with a program read from the memory 112 and based on a user operation. The memory 112 of the terminal device 101 stores various types of programs including an OS 121 and an AI scan program 122, and various types of data including use type information 123 and an AI scan parameter 124. The AI scan parameter 124 is information of a parameter suitable for executing the AI scan, similar to the AI scan parameter 24 of the first embodiment.

The user IF 113 includes hardware configured to display a screen for notifying a user of information, and hardware configured to receive an operation from the user. The communication IF 114 includes hardware for communicating with an external device. The terminal device 101 can be connected to the scanner 2 via the communication IF 114. The terminal device 101 may be connected to the Internet 100 via the communication IF 114, and may access the generative AI server 200 via the Internet 100. The scanner 2 may or may not be able to access the Internet 100 or the generative AI server 200.

Next, an AI scan procedure performed by the terminal device 101 according to the second embodiment will be described with reference to a sequence diagram of FIG. 10. In the second embodiment, the user can instruct the start of the AI scan procedure by operating the terminal device 101 (B01). For example, when receiving an execution instruction of the AI scan program 122, the terminal device 101 starts the AI scan procedure.

The terminal device 101 displays a use selection screen through the user IF 113 (B02) and receives the selection of the use (B03) as in the first embodiment. B03 is an example of a use reception process. The use selection screen displayed on the user IF 113 may be a screen same as or different from the use selection screen 60 (see FIG. 3B) of the first embodiment. The terminal device 101 acquires use data indicating a use based on the selection of the user.

After selecting the use, the user inputs the AI scan execution instruction to the terminal device 101 (B11). The AI scan execution instruction received in B11 is an example of the predetermined scan instruction.

The terminal device 101 transmits the AI scan parameter 124 stored in the memory 112 and a command indicating a scan execution instruction to the scanner 2 (B12). The scanner 2 executes the scan using the received AI scan parameter 124 (B13) and generates the scan data. Further, the scanner 2 transmits the generated scan data to the terminal device 101 (B14). Accordingly, the terminal device 101 acquires the scan data. B14 is an example of a scan data acquisition process.

Then, the terminal device 101 transmits the scan data acquired from the scanner 2 and the use data acquired in B03 to the generative AI server 200 (B21), and instructs the generative AI server 200 to answer whether the image included in the scan data is suitable for the use indicated in the use data. The instruction of B21 is the same as the instruction in A13 of the first embodiment. B21 is an example of the transmission process.

The terminal device 101 may be capable of receiving the execution instruction of B11 before the selection of the use. In this case, the terminal device 101 may receive the selection of the use before the start of transmission of B21, for example.

Similar to the first embodiment, the generative AI server 200 uses the learned model 201 to determine whether the image indicated in the input scan data is suitable for the input use (B22), and generates answer data including the determination information output by the learned model 201. Then, the generative AI server 200 outputs the generated answer data to the terminal device 101 (B23). Accordingly, after executing the transmission of B21, the terminal device 101 can receive the determination information indicating the suitability of the image indicated in the scan data from the generative AI server 200 via the communication IF 14.

If it is determined that the image is suitable for the use based on the determination information received from the generative AI server 200 (alt: [OK determination]), the terminal device 101 executes the post process of OK determination (B31). The post process of OK determination is a process same as the post process of OK determination (see FIG. 5) in the first embodiment, and is executed by the CPU 111 of the terminal device 101 based on the AI scan program 122 in the present embodiment.

If the determination result received from the generative AI server 200 is the OK determination, the CPU 111 of the terminal device 101 causes the user IF 113 to make a notification of the OK determination in S101 of the post process of OK determination. S101 of the post process of OK determination executed by the CPU 111 of the terminal device 101 is an example of an application notification process. The CPU 111 may be capable of receiving an instruction to save the image data.

On the other hand, if it is determined that the image is not suitable for the use based on the determination information received from the generative AI server 200 (alt: [not-OK determination]), the terminal device 101 executes the post process of not-OK determination (B32). The post process of not-OK determination is a process same as the post process of not-OK determination (see FIG. 7) of the first embodiment, and is executed by the CPU 111 of the terminal device 101 based on the AI scan program 122 in the present embodiment.

If the determination result received from the generative AI server 200 is the not-OK determination, the CPU 111 of the terminal device 101 causes the user IF 113 to make a notification of the not-OK determination in S201 of the post process of not-OK determination. S201 of the post process of not-OK determination executed by the CPU 111 of the terminal device 101 is an example of the application notification process. The CPU 111 may be capable of receiving a notification instruction of the reason information.

After B31 or B32, the terminal device 101 ends the AI scan procedure. The terminal device 101 may be capable of receiving a determination instruction for another photograph.

As described above in detail, the terminal device 101 of the second embodiment transmits the scan data generated by the scanner 2 to the generative AI server 200 using the learned model 201 together with the use data indicating the use of the document. When the determination information output from the learned model 201 is received, the terminal device 101 make a notification of the determination result of the learned model 201 indicated in the determination information via the user IF 113. Accordingly, similar to the first embodiment, the user can confirm whether the prepared document is suitable for the designated use.

The present embodiment is merely an example, and does not limit the present invention. Therefore, various improvements and modifications can be naturally made to the technique disclosed in the present specification without departing from the scope of the present invention. For example, the scanner may be a device having an image reading function and a communication function, and is not limited to the MFP 1, and may be a copy machine or a FAX device.

Further, the display form in each of the embodiments is not limited to the shown example. For example, the type, the number, the shape, and the like of the icons displayed on the standby screen 50 shown in FIG. 3A are not limited to the shown example. The instruction to start the AI scan procedure is not limited to the example of being received by the AI scan icon 52 included in the standby screen 50, and may be received by, for example, a menu displayed after the operation on the scan icon 51 is received. In this case, an operation on the menu is an example of the predetermined scan instruction. The use selection screen 60 may be a screen capable of receiving at least a selection of the use by the user, and the execution button 61 may be included in another screen.

In addition, the notification of the determination result is not limited to the notifications by the various notification screens 70, 80, and 90 shown in the drawings, and may be, for example, a notification by voice output, electronic mail transmission to a predetermined address, saving a file to a predetermined save destination, or printing. A display form of each notification screen is not limited to the shown example. For example, the notification screen 70 may not include the save button 71. For example, the reason notification screen 90 may not include the image save button 93. That is, the MFP 1 may not receive an instruction to save the image data based on the scan data or the reason image of the not-OK reason.

The reason information received from the generative AI server 200 is not limited to the reason image 91 indicated in an image or the reason text 92 represented by a text, and may be, for example, code information corresponding to various reasons. The reason information may be any information as long as the AI scan program 22 of the MFP 1 or the AI scan program 122 of the terminal device 101 can determine the notification content on the reason notification screen 90.

The MFP 1 or the terminal device 101 may be capable of receiving an instruction to change the AI scan parameter 24 by an operation different from the instruction to start the AI scan procedure.

In the post process of OK determination, the MFP 1 receives the selection of whether to output the image data (S105 in FIG. 5), but may not receive the selection. For example, in the case of the OK determination, the MFP 1 may end the determination simply by making the notification of the determination result, or may automatically save the determination result without receiving the selection.

In the post process of not-OK determination, the MFP 1 receives the selection of whether to display the reason (S205 in FIG. 7), but may not receive the selection. For example, in the case of the not-OK determination, the MFP 1 may automatically display the reason or may end the determination only by making the notification of the determination result. If the MFP 1 receives the reason information together with the determination result, the MFP 1 may also make a notification of the reason information together. In the post process of not-OK determination, the MFP 1 receives the selection of whether to save the image (S216 in FIG. 7), but may not receive the selection.

The generative AI server 200 is not limited to having the learned model 201, and may be capable of using the learned model 201 of another server. In this case, the generative AI server 200 passes the received scan data, use data, and the like to another server including the learned model 201, and transmits the answer data to the MFP 1 based on the answer by the learned model 201. That is, the generative AI server 200 is not limited to a server provided by an AI business operator such as OpenAI, and may be, for example, a dedicated server prepared by a manufacturer of the MFP 1 or the like.

In addition, in each of the embodiments, a configuration in which the learned model 201 of the generative AI server 200 is used has been exemplified, but a configuration using a program created based on coding of a programmer may be used instead of the learned model 201.

In any flowchart or sequence diagram disclosed in each of the embodiments, an execution order of a plurality of processes in any plurality of steps can be freely changed or can be executed in parallel within a range in which no contradiction occurs in a process content.

The processes disclosed in each of the embodiments may be executed by hardware such as a single CPU, a plurality of CPUs, and an ASIC, or a combination thereof. In addition, the processes disclosed in the embodiment can be implemented in various modes such as a recording medium in which a program for executing the processes is recorded, or a method.

What is claimed is:

1. A scanner comprising:
a reading engine;
a user interface; and
a communication interface,
wherein the scanner is configured to access a server via the communication interface, the server using a learned model that has learned so as to be configured to output, based on input data, determination information including information as to whether an image is suitable for a use,
wherein in a case in which a predetermined scan instruction is received via the user interface, the scanner is configured to execute:
a scan process of scanning a document by using the reading engine, and generating scan data indicating a document image based on a scan result;
a designation process of receiving designation of a use for the document image via the user interface; and
a transmission process of transmitting, to the server via the communication interface, the scan data generated in the scan process and use data indicating the use received in the designation process, and
wherein in a case in which the determination information output by the learned model and including the information as to whether the image indicated in the scan data is suitable for the use indicated in the use data is received from the server via the communication interface, the scanner is configured to execute a notification process of outputting, based on the determination information, a notification via the user interface, the notification indicating whether the document image read in the scan process is suitable for the use designated in the designation process.

2. The scanner according to claim 1,
wherein the use to be designated in the designation process is allowed to be selected from at least one use option, the at least one use option including a use of a photograph used for a visa application to a specific country.

3. The scanner according to claim 1,
wherein the use to be designated in the designation process is allowed to be selected from at least one use option, the at least one use option including a use of a photograph used for a passport application.

4. The scanner according to claim 1,
wherein the scanner is configured to:
display, on the user interface, a standby screen including an operator corresponding to a scan, and receive a setting operation of a parameter related to generation of the scan data after the operator is operated;
receive, via the user interface, the predetermined scan instruction without receiving the setting operation; and
execute the scan process, the designation process, and the transmission process in a case in which the predetermined scan instruction is received without receiving the setting operation, the scan process being executed to scan the document with a predetermined parameter, and
wherein the scanner is configured to execute the notification process in a case in which the determination information is received from the server via the communication interface.

5. The scanner according to claim 1,
wherein in a case in which the determination information indicating that the image indicated in the scan data is suitable for the use indicated in the use data, the scanner is configured to execute an output process of outputting image data, the image data being based on the scan data generated in the scan process and in an image format suitable for the use received in the designation process.

6. The scanner according to claim 5,
wherein the scanner is configured to receive, from the server via the communication interface, the image data in the image format suitable for the use received in the designation process, the image data being output by the learned model that has learned so as to be configured to output, based on input scan data, the image data in the image format suitable for an input use, and
wherein in the output process, the scanner is configured to output the image data received from the server via the communication interface and in the image format suitable for the use received in the designation process.

7. The scanner according to claim 6,
wherein the scanner is configured to receive, from the server via the communication interface, the image data together with the determination information indicating that the image indicated in the scan data is suitable for the use indicated in the use data, and
wherein in the output process, the scanner is configured to output the image data received, together with the determination information, from the server via the communication interface and in the image format suitable for the use received in the designation process.

8. The scanner according to claim 6,
wherein in a case in which the determination information indicating that the image indicated in the scan data is suitable for the use indicated in the use data is received and the image data in the image format suitable for the use received in the designation process is not received, the scanner is configured to:
execute an output selection process of receiving a selection of whether to output the image data via the user interface;
in a case in which a selection to output the image data is received in the output selection process, transmit an image acquisition request for acquiring the image data to the server via the communication interface, and execute the output process in a case of receiving the image data from the server, the image data being output by the learned model in response to the image acquisition request and in the image format suitable for the use received in the designation process; and
in a case in which a selection not to output the image data is received in the output selection process, not to execute the output process.

9. The scanner according to claim 6,
wherein the scanner is configured to receive, from the server via the communication interface, the image data in the image format suitable for the use received in the designation process and obtained by applying a trimming processing to the scan data to trim a part of the image indicated in the scan data to suit the use received in the designation process, the image data being output by the learned model that has learned so as to be configured to output, based on input scan data, the image data in the image format suitable for an input use and obtained by applying a trimming processing to the input scan data to trim a part of an image indicated in the input scan data so as to suit the input use, and
wherein in the output process, the scanner is configured to output the image data received from the server via the communication interface, the image data being in the image format suitable for the use received in the designation process and obtained by applying a trimming processing to the scan data to trim a part of the image indicated by the scan data to suit the use received in the designation process.

10. The scanner according to claim 9,
wherein in the transmission process, the scanner is configured to transmit, to the server via the communication interface, the scan data generated in the scan process and not being subjected to the trimming processing and the use data indicating the use received in the designation process, and
wherein in the output process, the scanner is configured to output the image data received from the server via the communication interface, the image data being in the image format suitable for the use received in the designation process and obtained by applying the trimming processing to the scan data to trim a part of the image indicated in the scan data to suit the use received in the designation process.

11. The scanner according to claim 5,
wherein in a case in which the determination information indicating that the image indicated in the scan data is suitable for the use indicated in the use data is received, the scanner is configured to:
execute an output selection process of receiving a selection of whether to output the image data via the user interface;
in a case in which a selection to output the image data is received in the output selection process, execute the output process; and
in a case in which a selection not to output the image data is received in the output selection process, not to execute the output process.

12. The scanner according to claim 1,
wherein the scanner is configured to receive, from the server via the communication interface, reason information indicating a reason why the image is not suitable for the use, the reason information being output by the learned model that has learned so as to be configured to output the reason information indicating the reason why the image is not suitable for the use in a case in which the determination information indicating that the image is not suitable for the use is output, and
wherein in a case in which the determination information indicating that the image indicated in the scan data is not suitable for the use indicated in the use data is received, the scanner is configured to execute a display process of displaying, based on the reason information, the reason why the image is not suitable for the use via the user interface.

13. The scanner according to claim 12,
wherein the reason information includes text data indicating the reason why the image is not suitable for the use by a text, the reason information including the text data being output by the learned model that has learned so as to be configured to output the reason information indicating the reason why the image is not suitable for the use by the text in a case in which the determination information indicating that the image is not suitable for the use is output, and
wherein in the display process, the text based on the reason information is displayed via the user interface.

14. The scanner according to claim 12,
wherein the reason information includes image data indicating the reason why the image is not suitable for the use by an image, the reason information including image data being output by the learned model that has learned so as to be configured to output the reason information indicating the reason why the image is not suitable for the use by the image in a case in which the determination information indicating that the image is not suitable for the use is output, and
wherein in the display process, the image based on the reason information is displayed via the user interface.

15. The scanner according to claim 14,
wherein the scanner is configured to receive, from the server via the communication interface, the reason information together with the determination information indicating that the image indicated in the scan data is not suitable for the use indicated in the use data, and
wherein in the display process, the scanner is configured to display, via the user interface, the image based on the reason information received from the server via the communication interface together with the determination information.

16. The scanner according to claim 14,
wherein in a case in which the determination information indicating that the image indicated in the scan data is not suitable for the use indicated in the use data is received and the reason information is not received, the scanner is configured to:
execute a display selection process of receiving a selection of whether to display the reason why the image is not suitable for the use via the user interface;
in a case in which a selection to display the reason why the image is not suitable for the use is received in the display selection process, transmit a reason acquisition request for acquiring the reason information to the server via the communication interface, and execute the display process in a case of receiving the reason information output by the learned model in response to the reason acquisition request from the server; and
in a case in which a selection not to display the reason why the image is not suitable for the use is received in the display selection process, not to execute the display process.

17. The scanner according to claim 12,
wherein the use to be designated in the designation process is allowed to be selected from at least one use option, the at least one use option including a use of a photograph used for an application to a predetermined institution,
wherein the reason information corresponding to the use of the photograph used for the application to the predetermined institution includes insufficient brightness of a facial image, and
wherein in the display process, in a case in which the reason information received from the server includes the insufficient brightness of the facial image, information indicating the insufficient brightness of the facial image is displayed via the user interface.

18. The scanner according to claim 12,
wherein the use to be designated in the designation process is allowed to be selected from at least one use option, the at least one use option including a use of a photograph used for an application to a predetermined institution,
wherein the reason information corresponding to the use of the photograph used for the application to the predetermined institution includes an orientation of a facial image, and
wherein in the display process, in a case in which the reason information received from the server includes the orientation of the facial image, information indicating that the orientation of the facial image is inappropriate is displayed via the user interface.

19. The scanner according to claim 12,
wherein the use to be designated in the designation process is allowed to be selected from at least one use option, the at least one use option including a use of a photograph used for an application to a predetermined institution,
wherein the reason information corresponding to the use of the photograph used for the application to the predetermined institution includes a size of a facial image, and
wherein in the display process, in a case in which the reason information received from the server includes the size of the facial image, information indicating that the size of the facial image is inappropriate is displayed via the user interface.

20. The scanner according to claim 12,
wherein the use to be designated in the designation process is allowed to be selected from at least one use option, the at least one use option including a use of a photograph used for an application to a predetermined institution,
wherein the reason information corresponding to the use of the photograph used for the application to the predetermined institution includes noise of a facial image, and
wherein in the display process, in a case in which the reason information received from the server includes the noise of the facial image, information indicating that the noise is included in the facial image is displayed via the user interface.

21. A non-transitory computer readable storage medium storing a program, the program, when executed by one or more processors, causing an information processing device to perform operations, the operations comprising:
in a case in which a predetermined scan instruction is received,
executing a scan data acquisition process of instructing a scanner connected to the information processing device to scan a document and acquiring, from the scanner, scan data indicating a document image based on a scan result;
executing a use reception process of receiving designation of a use for the document image; and
executing a transmission process of transmitting, to a server connected to the information processing device, the scan data acquired in the scan data acquisition process and use data indicating the use received in the use reception process, the server using a learned model that has learned so as to be configured to output, based on input data, determination information including information as to whether the image is suitable for the use,
wherein the operations further comprise, in a case in which the information processing device receives, from the server, the determination information output by the learned model and including the information as to whether the image indicated in the scan data is suitable for the use indicated in the use data, executing an application notification process of outputting, based on the determination information, a notification indicating whether the document image read by the scanner in the scan data acquisition process is suitable for the use received in the use reception process.
